(19) United States
(12) Patent Application Publication
(10) Pub. No.: US 2017/0171048 A1
(43) Pub. Date: Jun. 15, 2017

(54) AUTOMATED DETECTION AND ANALYSIS OF CALL CONDITIONS IN COMMUNICATION SYSTEM

(71) Applicant: Unify Square, Inc., Bellevue, WA (US)

(72) Inventors: Thomas Christmann, Framingham, MA (US); Rokas Tamosevicius, Zürich (CH); Mark Herbert Achzenick, San Diego, CA (US); Robert Osborne, Redmond, WA (US); Arun Raghavan, Seattle, WA (US)

(73) Assignee: Unify Square, Inc., Bellevue, WA (US)

(21) Appl. No.: 15/374,708

(22) Filed: Dec. 9, 2016

Related U.S. Application Data
(60) Provisional application No. 62/265,333, filed on Dec. 9, 2015.

(51) Int. Cl. H04L 12/26

(52) U.S. Cl. CPC H04L 43/08; H04L 43/16; H04L 43/045; H04L 12/4641

(57) ABSTRACT

A computing device automatically detects technical conditions for calls, such as voice calls, in a communication system. The technical conditions include transport type (e.g., TCP, UDP), connection type (e.g., wired, wireless local area network, mobile/cellular), packet loss, latency, and jitter. The computing device performs automatic analysis of the detected technical conditions. The automatic analysis may include comparing the detected transport type with a preferred transport type (e.g., a non-TCP transport, such as UDP), comparing the detected connection type with a preferred connection type (e.g., wired), or comparing packet loss, latency, or jitter with corresponding threshold values (e.g., maximum values or average values). The computing device automatically generates output related to one or more of the detected technical conditions based at least in part on the automatic analysis. Such output may be triggered, for example, by wireless calls where packet loss, latency, or jitter exceeds a corresponding threshold value.

### CROSS-REFERENCE TO RELATED APPLICATION

This application claims the benefit of U.S. Provisional Application No. 62/265,333, filed Dec. 9, 2015.

### BACKGROUND

Unified communication (UC) services include communication services (e.g., e-mail services, instant messaging services, voice communication services, video conference services, and the like) and UC data management and analysis services. UC platforms allow users to communicate over internal networks (e.g., corporate networks) and external networks (e.g., the Internet). This opens communication capabilities not only to users available at their desks, but also to users who are on the road and even to users from different organizations. With such solutions, end users are freed from limitations of previous forms of communication, which can result in quicker and more efficient business processes and decision making.

However, the quality of communications in such platforms can be affected by a variety of problems, including software failures, hardware failures, configuration problems (e.g., system-wide or within components, such as firewalls and load balancers), and network performance problems. The potential impacts of these and other problems include immediate impact upon end users (both internal and roaming) as well as inefficient use of resources.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computing device automatically detects technical conditions for calls, such as voice calls, in a communication system. The technical conditions include transport type (e.g., TCP, UDP), connection type (e.g., wired, wireless local area network, mobile/cellular), packet loss, latency, and jitter. The computing device performs automatic analysis of the detected technical conditions. The automatic analysis may include comparing the detected transport type with a preferred transport type (e.g., a non-TCP transport, such as UDP), comparing the detected connection type with a preferred connection type (e.g., wired), or comparing packet loss, latency, or jitter with corresponding threshold values (e.g., maximum values or average values). The computing device automatically generates output related to one or more of the detected technical conditions based at least in part on the automatic analysis. The computing device causes the output is displayed (e.g., in a user interface of a help desk application), either at the computing device that performs the process, or at some other location.

The detected technical conditions may further include access type (e.g., VPN or non-VPN), stream quality, and devices used during the calls (e.g., capture or rendering devices, such as headsets). The output may be triggered, for example, where the detected transport type is TCP. As another example, the output may be triggered by calls made via a wireless access point (or a wired connection outside an enterprise) where packet loss, latency, or jitter exceeds its corresponding threshold value.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram that illustrates a generalized UC management and analysis system in which aspects of the present disclosure may be implemented;

FIG. 2 is a block diagram that illustrates another example of a UC management and analysis system in which an automated call condition detection and analysis system may be implemented;

FIGS. 3A and 3B are tables representing an algorithmic process that may be employed by an automated call condition detection and analysis system to analyze detected call conditions, according to embodiments described herein;

FIGS. 4A-4D are screen shots of a user interface for displaying information based on output generated by an automated call condition detection and analysis system, according to embodiments described herein;

FIG. 5 is a flowchart of an illustrative process for automatically detecting technical conditions for calls, analyzing the detected conditions, and generating output based on the analysis; and

FIG. 6 is a block diagram that illustrates aspects of an illustrative computing device appropriate for use in accordance with embodiments of the present disclosure.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

### I. Unified Communication System Overview

The present disclosure includes descriptions of various aspects of unified communication (UC) systems, such as UC management and analysis systems, and related tools and techniques. In general, UC systems (including UC systems based on Skype® For Business or Lync® platforms available from Microsoft Corporation, or other UC systems) provide UC services. UC services may include communication services (e.g., e-mail services, instant messaging services, voice communication services, video conference services, and the like) and UC data management and analysis services, or other services.

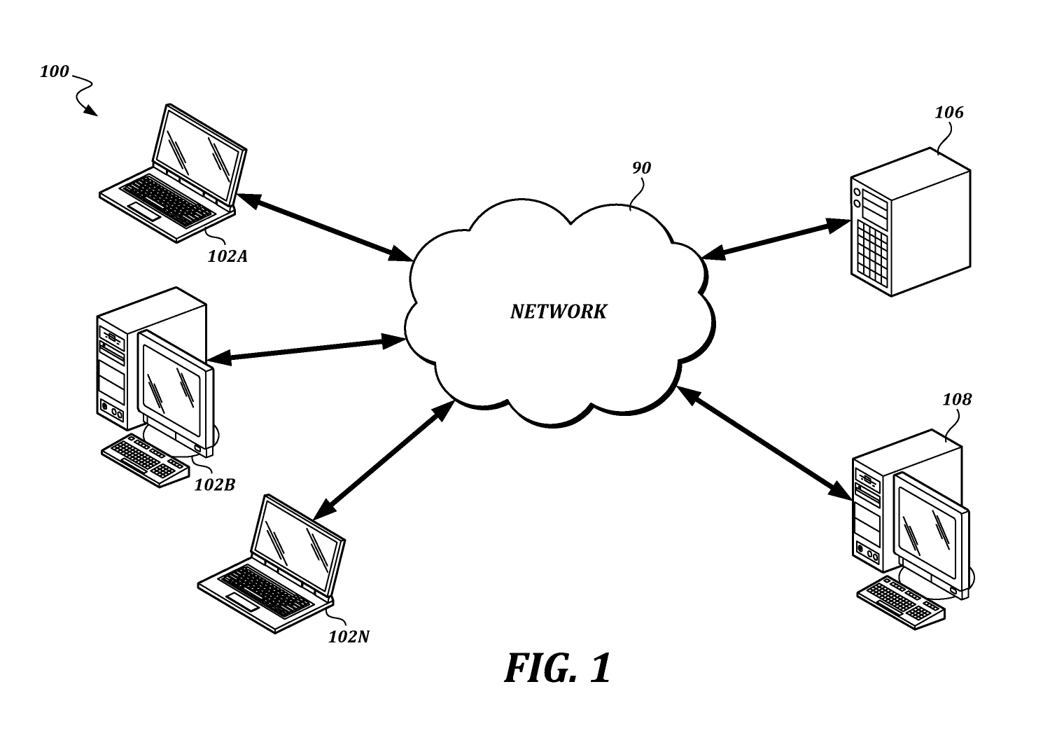

FIG. 1 is a block diagram that illustrates a generalized UC management and analysis system 100 according to various aspects of the present disclosure. In this generalized example, the system 100 includes client computing devices 102A-N, a server computing device 106, and an administrator computing device 108. The components of the system 100 may communicate with each other via a network 90. For example, the network 90 may comprise a wide-area network such as the Internet. The network 90 may comprise one or more sub-networks (not shown). For example, the network 90 may include one or more local area networks (e.g., wired or wireless local area networks) that may, in turn, provide access to a wide-area network such as the Internet. The client computing devices 102A-N may be computing devices operated by end users of a UC system. A user operating the administrator computing device 108 may connect to the server computing device 106 to, for example, manage and analyze use of the UC system.

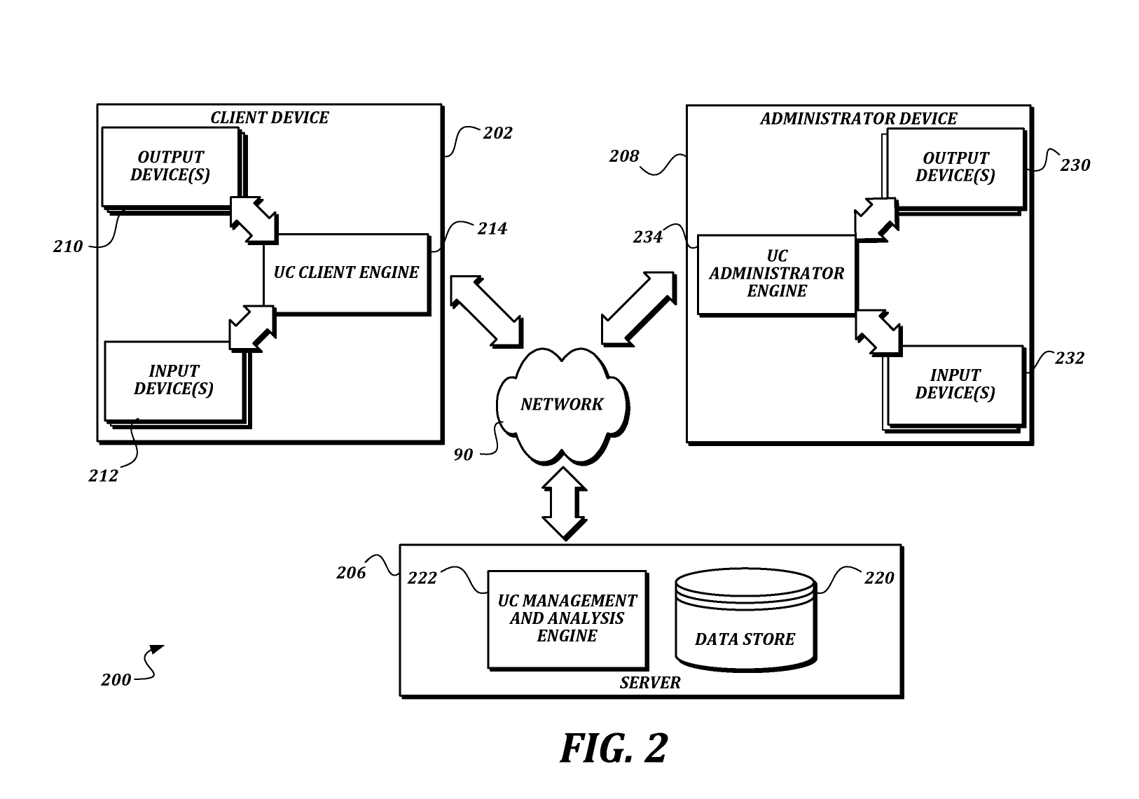

FIG. 2 is a block diagram that illustrates another example of a UC management and analysis system. As shown in FIG. 2, the system 200 comprises a client computing device 202, a server 206, and an administrator computing device 208.

In the example shown in FIG. 2, the server computing device 206 comprises a data store 220 and implements a UC management and analysis engine 222. (Other components of the server computer device 206, such as memory and one or more processors, are not shown for ease of illustration.) The data store 220 stores data that relates to operation and use of the UC system, as will be further described below. The management and analysis engine 222 interacts with the data store 220. The data store 220 can store data and definitions that define elements to be displayed to an end user on a client computing device 202 or administrator computing device 208. For example, the data store 220 can store data that describes the frequency, quality, and other characteristics of communications (e.g., voice communications) that occur across an enterprise via a UC system. As another example, a definition defining a set of interface elements can be used to present a graphical user interface at administrator computing device 208 that can be used by a system administrator that is seeking to diagnose the cause of a reported problem in the UC system, as explained in detail below.

In the example shown in FIG. 2, the client computing device 202 includes output device(s) 210 and input device(s) 212 and executes a UC client engine 214. (Other components of the client computing device 202, such as memory and one or more processors, are not shown for ease of illustration.) In at least one embodiment, software corresponding to the UC client engine 214 is provided to the client computing device 202 in a cloud-based software distribution model. In a cloud-based model, the UC client engine 214 may be provided by an application server (not shown) or by some other computing device or system.

The UC client engine 214 is configured to process input and generate output related to UC services and content (e.g., services and content provided by the server 206). The UC client engine 214 also is configured to cause output device(s) 210 to provide output and to process input from input device(s) 212 related to UC services. For example, input device(s) 212 can be used to provide input (e.g., text input, video input, audio input, or other input) that can be used to participate in UC services (e.g., instant messages (IMs), voice calls, video calls), and output device(s) 210 (e.g., speakers, a display) can be used to provide output (e.g., graphics, text, video, audio) corresponding to UC services.

In the example shown in FIG. 2, the administrator computing device 208 includes output device(s) 230 and input device(s) 232 and executes a UC administrator engine 234. (Other components of the administrator computing device 208, such as memory and one or more processors, are not shown for ease of illustration.) In at least one embodiment, software corresponding to the UC administrator engine 234 is provided to the administrator computing device 208 in a cloud-based software distribution model. In a cloud-based model, the UC administrator engine 234 may be provided by an application server (not shown) or by some other computing device or system.

The UC administrator engine 234 is configured to receive, send, and process information relating to UC services. The UC administrator engine 234 is configured to cause output device(s) 230 to provide output and to process input from input device(s) 232 related to UC services. For example, input device(s) 232 can be used to provide input for administering or participating in UC services, and output device(s) 230 can be used to provide output corresponding to UC services.

The UC client engine 214 and/or the UC administrator engine 234 can be implemented as a custom desktop application or mobile application, such as an application that is specially configured for using or administering UC services. Alternatively, the UC client engine 214 and/or the UC administrator engine 234 can be implemented in whole or in part by an appropriately configured browser, such as the Internet Explorer® browser by Microsoft Corporation, the Firefox® browser by the Mozilla Foundation, and/or the like. Configuration of a browser may include browser plug-ins or other modules that facilitate instant messaging, recording and viewing video, or other functionality that relates to UC services.

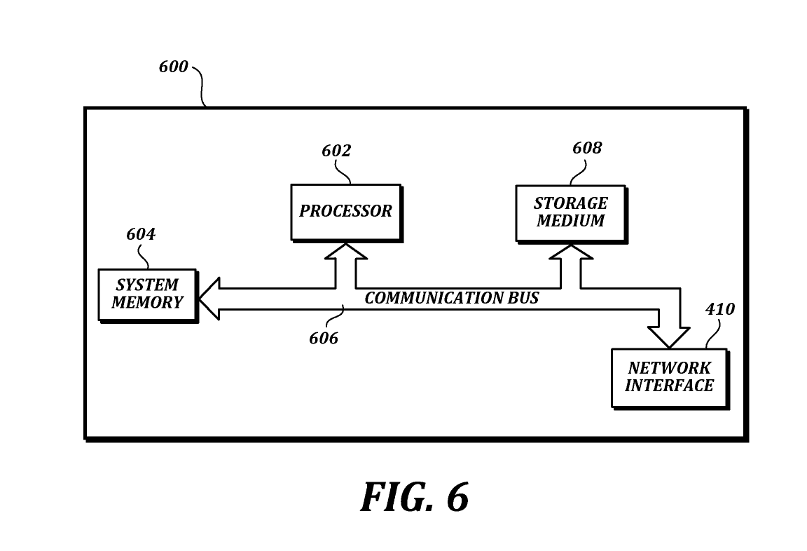

In any of the described examples, an “engine” may include computer program code configured to cause one or more computing device(s) to perform actions described herein as being associated with the engine. For example, a computing device can be specifically programmed to perform the actions by having installed therein a tangible computer-readable medium having computer-executable instructions stored thereon that, when executed by one or more processors of the computing device, cause the computing device to perform the actions. An exemplary computing device is described further below with reference to FIG. 6. The particular engines described herein are included for ease of discussion, but many alternatives are possible. For example, actions described herein as associated with two or more engines on multiple devices may be performed by a single engine. As another example, actions described herein as associated with a single engine may be performed by two or more engines on the same device or on multiple devices.

In any of the described examples, a “data store” contains data as described herein and may be hosted, for example, by a database management system (DBMS) to allow a high level of data throughput between the data store and other components of a described system. The DBMS may also allow the data store to be reliably backed up and to maintain a high level of availability. For example, a data store may be accessed by other system components via a network, such as a private network in the vicinity of the system, a secured transmission channel over the public Internet, a combination of private and public networks, and the like. Instead of or in addition to a DBMS, a data store may include structured data stored as files in a traditional file system. Data stores may reside on computing devices that are part of or separate from components of systems described herein. Separate data stores may be combined into a single data store, or a single data store may be split into two or more separate data stores.

### Voice Quality Overview

Maintaining acceptable audio quality requires an understanding of UC system infrastructure and proper functioning of the network, communication devices, and other components. An administrator will often need to be able to quantifiably track overall voice quality in order to confirm improvements and identify areas of potential difficulty (or “hot spots”) that require further effort to resolve. There may be a hierarchy of issues, ranging from network issues (typically being both common and important to fix), to issues that are specific to local users (such as whether local users are using non-optimal devices), to issues that are specific to remote users, over which an administrator may have little control. Such issues may affect other forms of communication as well, such as video calls.

In order to isolate a grouping of calls with poor voice quality, it is important to have consistent and meaningful classification of calls. For example, wireless calls which have poor voice quality are important to group together to identify common patterns (e.g., whether the calls involve the same user) and to take appropriate action (e.g., educate the user to not use wireless, or upgrade the wireless infrastructure).

Additionally, some problems may have more impact on voice quality than others, even within the same call. For example, a user who is using a wireless connection and is roaming outside the user's usual network may be calling another user who is on the corporate network using a wired connection. In this case, the overall experience may be impacted by the first user's wireless connection. An analysis of the conditions at the two endpoints can be conducted to determine which endpoint is more likely to impact a call and highlight one or more items to consider addressing (e.g., by encouraging a user to switch from a wireless connection to a wired connection for the next call).

Classification of calls with certain general common characteristics may be helpful at some level for understanding voice quality issues. However, further classification may be needed for better understanding of a problem. The further classification may include any of several factors, including geography (users, infrastructure, etc.), time, specific site, etc. Regarding time, classification and analysis at different levels of time granularity (e.g., weekly, monthly, daily) may be used, and may allow for a corresponding ability to view trends over time (e.g., week-to-week, month-to-month, year-to-year). Not all classifications or geographies with poor audio quality will require the same level of attention. For example, a geography that is having 1 poor call out of 10 is likely worth investing more time in than one with 1 poor call out of 100.

The definition of a poor call can be provided by a UC platform, by an enterprise that uses the UC platform, or in some other way. The definition of a poor call may differ between platforms or enterprises, but it includes specific criteria for consistent classification of calls for the particular platform or enterprise.

In at least one embodiment, a poor call is defined as a call with one or more call quality metrics (e.g., degradation, latency, packet loss, jitter, or other metrics) that are outside a predefined value range. Metrics that can lead to a call being classified as poor in an illustrative UC platform are shown in Table 1, below, along with illustrative threshold values.

TABLE 1
Illustrative metrics and threshold values for poor calls.

| Metric | Threshold | Meaning |
|---|---|---|
| Degradation | >1.0 | Network Mean Opinion Score (MOS) |
| average | | degradation for call (reduction in Network |
| | | MOS due to jitter/packet loss). In this |
| | | context, the Network MOS does not |
| | | measure actual user opinion of particular |
| | | calls, but instead is an automatically |
| | | calculated score based on call |
| | | characteristics, such as jitter and packet |
| | | loss. |
| Latency | >500 ms | Round trip time for corresponding data |
| | | packets. Can result in unacceptable delay. |
| Packet Loss | >0.1 (10%) | Average rate of packet loss, where packet |
| Rate | | fails to reach destination—can result in |
| | | distorted/missing audio signal. |
| Average | >30 ms | Average delay between packet arrivals— |
| Network | | can result in distorted/missing audio |
| Jitter | | signal. |
| Concealed | >0.07 | Average ratio of concealed samples to |
| Samples | | total samples, where concealed audio |
| Ratio | | samples are modified to smooth |
| (Average) | | transitions between packets in case of |
| | | packet loss or jitter—can result in |
| | | distorted audio. |

The particular metrics used to classify a call as poor, as well as the threshold values for such metrics, can vary depending on implementation and may be adjustable, as well, based on specific requirements or preferences. The metrics used to classify a call as poor may be detected by a UC system itself, or by monitoring software deployed in combination with a UC system.

A threshold for an acceptable amount of poor calls also can be provided by a UC platform, by an enterprise, or in some other way. As an example, 2% may be set as a threshold percentage (or maximum acceptable percentage) of poor calls. Other lower or higher threshold percentages also may be used. Such thresholds may be set by default and may be modified if desired.

### II. Automated Detection and Analysis of Call Conditions in Communication System

In this section, various examples of features that may be included in a system for automated detection and analysis of call conditions in a communication system (e.g., a UC system) are described. Referring again to FIG. 2, the automated call condition detection and analysis system may be implemented, for example, as part of the UC management and analysis engine 222 of server computing device 206, the UC administrator engine 234 of administrator computing device 208, or the UC client engine 214 of client computing device 202, or it may be distributed among multiple devices. The individual features described in this section may be implemented together, independently, or in various subsets, as may be appropriate for a particular implementation. Features described in this section may be implemented along with or independent of any of the features described in Section I, above.

The automated call condition detection and analysis system can be described as having an automated detection subsystem and an automated analysis subsystem. The detection subsystem automatically detects technical conditions related to communications, such as voice calls in a UC system. These automatically detected conditions are provided as input to the automated analysis subsystem, which uses technical condition analysis engine to process the input and automatically generate output (e.g., messages or guidance for display) based on the analysis.

In examples described herein, the automated call condition detection and analysis system provides technical solutions to technical problems that are specific to communication system technology. For example, a UC system typically provides more than one way to engage in any particular type of electronic communication, such as a voice call, and each of those ways may have different effects on communication quality. This leads to a wide range of possible communication scenarios and related quality issues that are unique to UC system technology. A user will often not know even the most basic technical details of his communication method. In such situations, it is impossible for the user to diagnose or resolve communication quality issues on his own, or to accurately relate all the technical details that may affect communication quality to a technician. Similarly, without accurate information, it is impossible for the technician to give accurate guidance on how to improve communication quality.

Embodiments described herein overcome these and other technical problems by automatically detecting technical conditions of UC communications and automatically generating output (e.g., to a user interface) based on the detected conditions that allows the technical conditions to be adjusted (e.g., by an end user, technician, or administrator) such that voice quality issues and other issues can be efficiently resolved. As an example, in the context of a voice call, an automated detection subsystem may automatically detect technical conditions for the voice call including transport type (e.g., Transmission Control Protocol (TCP) or User Datagram Protocol (UDP)), connection type (e.g., wireless local area network, wired, or mobile/cellular connection), packet loss, latency, jitter, and input device (e.g., headset or microphone) model. These automatically detected conditions are provided as input to the automated analysis subsystem, which uses a technical condition analysis engine to process the input and automatically generate output (e.g., for display via a user interface).

Consider the following illustrative scenario: during a voice call, the automated detection subsystem automatically detects transport type as TCP and connection type as wireless, and also automatically detects packet loss rate (e.g., 0.3 (30%)), latency (e.g., 300 ms), and jitter (e.g., 45 ms) values. The automated detection subsystem provides this information to the automated analysis subsystem, which uses a technical condition analysis engine to process the input and automatically generate output (e.g., for display via a user interface). In this example, the output indicates multiple actions that a user or administrator can take in this situation, including the following:

1. Advise the user to switch to a wired connection and avoid a wireless connection while placing or receiving a UC call.

2. Advise a system administrator to check one or more configuration parameters on one or more UC system servers.

3. Advise the user to use a supported device (e.g., headset) while placing or receiving a UC call.

### Example 1

### Technical Condition Analysis Engine

In this example, a technical condition analysis engine is described that can be used to automatically select and provide prescriptive guidance to users (e.g., IT/help desk personnel or end users) based on available UC system data to help diagnose and/or resolve UC system issues, such as poor voice quality issues. The result of the application of such an engine can be presented in a user interface, such as in the form of a help desk or technical support page or dedicated application.

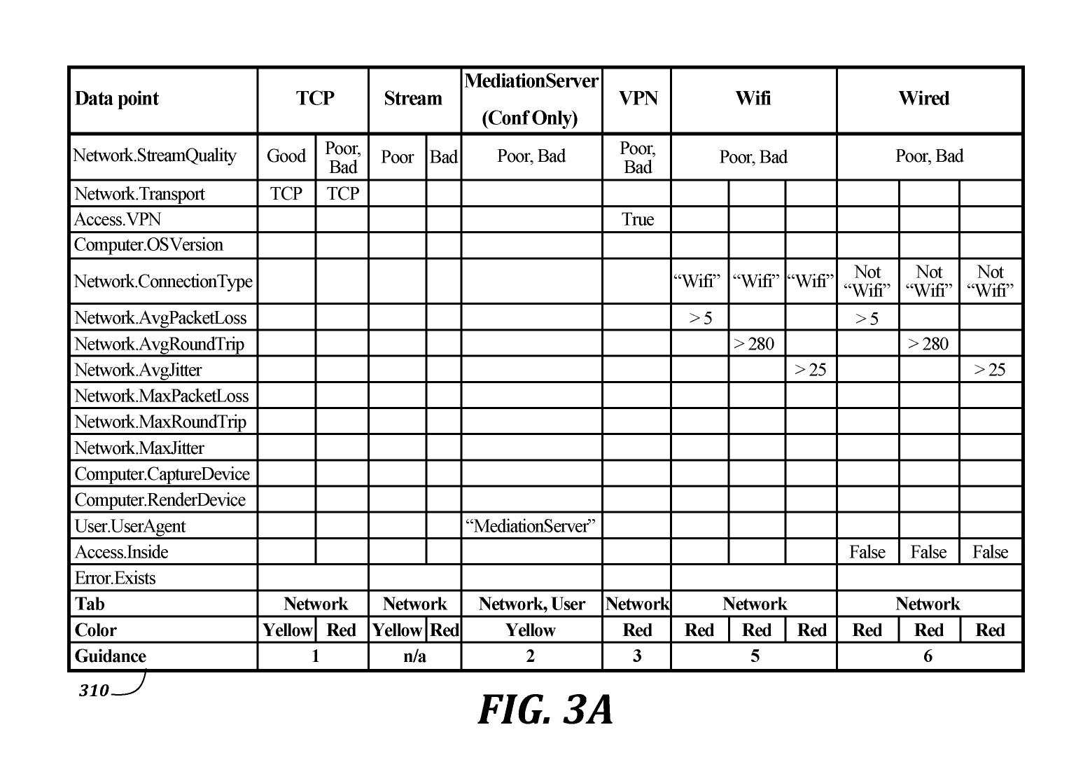

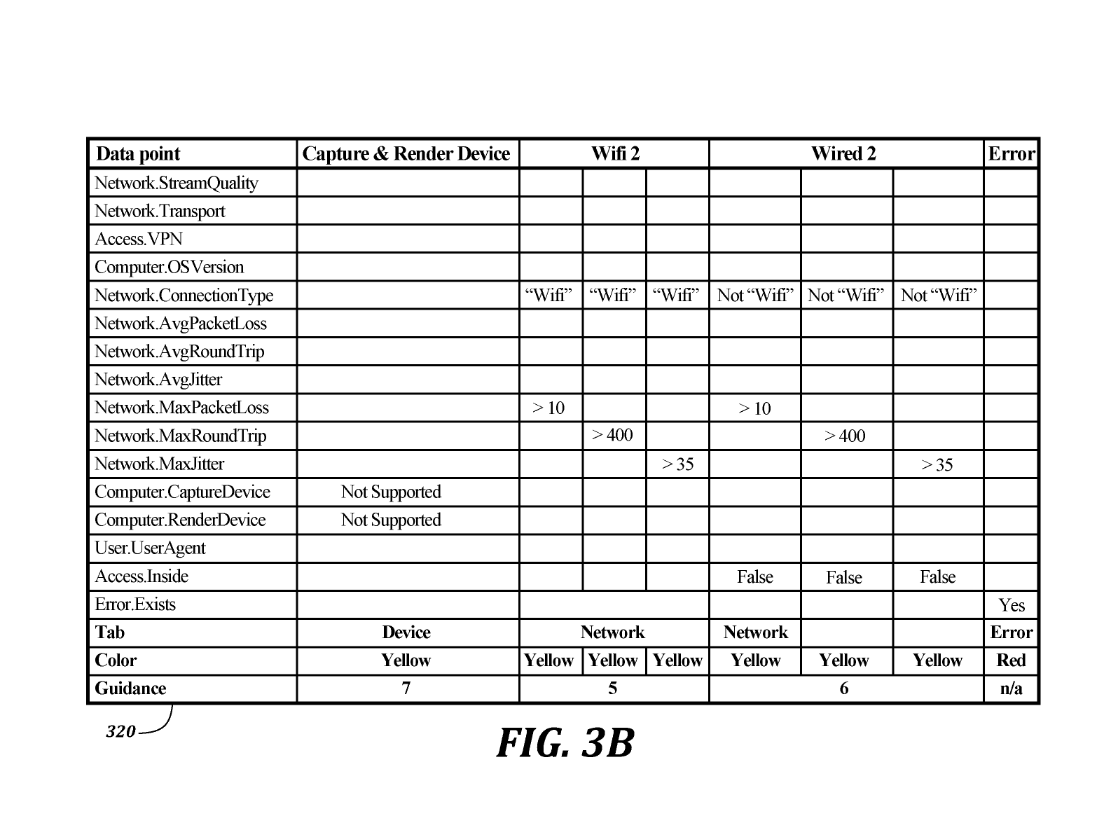

In at least one embodiment, the following data points represent technical conditions for calls in the technical condition analysis engine, as shown in FIGS. 3A and 3B: Network.StreamQuality (e.g., Good, Poor, or Bad); Network.Transport (e.g., TCP or UDP); Access.VPN (a true/false value); Computer.OSVersion, Network.ConnectionType (e.g., WiFi or not WiFi); Network.AvgPacketLoss and Network.MaxPacketLoss (expressed as percentages); Network.AvgRoundTrip and Network.MaxRoundTrip (latency measurements, in milliseconds); Network.AvgJitter and Network.MaxJitter (in milliseconds); Computer.CaptureDevice and Computer.RenderDevice (indicating whether the devices used are supported devices); User.UserAgent (indicating whether a mediation server is used); Access.Inside; and Error.Exists. The number and nature of the data points that are used may vary depending on factors such as the technical conditions that are automatically detected in a given system, and the types and granularity of guidance to be given.

In at least one embodiment, the value of Network.StreamQuality is determined as follows for audio calls. In this example, stream quality for a call is classified as Bad or Poor if any of the respective thresholds are exceeded, and if none are exceeded, the call is classified as Good.

TABLE 2
Illustrative classification of Bad, Poor, and Good calls

| Classification | Meaning |
|---|---|
| Bad | Degradation average > 1.0; or |
| | Latency (round trip) > 500 ms; or |
| | Packet loss rate > 0.1 (10%); or |
| | Average jitter > 30 ms; or |
| | Concealed Samples Ratio (Average) > 0.07 |
| Poor | Degradation average > 0.6; or |
| | Latency (round trip) > 200 ms; or |
| | Packet loss rate > 0.05 (5%); or |
| | Average jitter > 20 ms; or |
| | Concealed Samples Ratio (Average) > 0.03 |
| Good | Call metrics below the thresholds above. |

### Network.StreamQuality

The thresholds for classifying stream quality shown in Table 2 are only examples and may be replaced with other thresholds or combinations of threshold, depending on implementation.

In the example shown in FIGS. 3A and 3B, an algorithmic process that may be employed by the technical condition analysis engine is represented in tables 310 and 320. The technical condition analysis engine analyzes values of the data points alone or in various combinations, allowing the system to automatically generate output (represented in tables 310 and 320 as a guidance ID) that may be applicable to various categories. For example, use of a TCP connection may cause Guidance 1 to be displayed, with the condition being flagged as yellow (medium priority) or red (high priority) depending on whether the stream quality is Good, Poor, or Bad. As another example, use of a virtual private network (VPN) may cause Guidance 3 to be displayed with high priority if the stream quality is Poor or Bad. For WiFi connections, Guidance 5 may be displayed with the condition being flagged as high priority if the stream quality is Poor or Bad and Network.AvgPacketLoss, Network.AvgRoundTrip, or Network.AvgJitter is greater than the thresholds depicted in the WiFi column in FIG. 3A, or medium priority if Network.MaxPacketLoss, Network.MaxRoundTrip, or Network.MaxJitter is greater than the thresholds depicted in the WiFi 2 column in FIG. 3B.

For wired connections outside the enterprise (Access.Inside=False), Guidance 6 may be displayed with high priority if the stream quality is Poor or Bad and Network.AvgPacketLoss, Network.AvgRoundTrip, or Network.AvgJitter is greater than the thresholds depicted in the Wired column in FIG. 3A, or medium priority if Network.MaxPacketLoss, Network.MaxRoundTrip, or Network.MaxJitter is greater than the thresholds depicted in the Wired 2 column in FIG. 3B. (The thresholds shown in FIGS. 3A and 3B are only examples and may be replaced with other thresholds, depending on implementation or needs of a particular enterprise.) As another example, use of an unsupported capture or rendering device may cause Guidance 7 to be displayed as medium priority, regardless of stream quality. Other rules and categories, such as the additional examples shown in FIGS. 3A and 3B, or other rules or categories, also may be used.

In at least one embodiment, the following illustrative prescriptive guidance can be provided via a user interface, with specific guidance associated with the illustrative Guidance IDs shown in FIGS. 3A and 3B (see Table 3, below):

TABLE 2
Guidance associated with the illustrative Guidance IDs.

| ID | Headline | Explanation |
|---|---|---|
| 1 | TCP can cause | Call was made utilizing TCP network connection, |
| | jitter | which can cause poor audio due to conditions |
| | | such as jitter. If this is not a common problem, |
| | | and only this user is experiencing jitter, then |
| | | firewall settings of the user's network may need |
| | | to be examined. |
| 2 | Data | A voice quality issue occurred within the data |
| | Center/Server | center and/or associated servers. Investigation by |
| | problems | an engineering team may be required. |
| 3 | VPN is not | Use of VPN can impact audio quality. Consider |
| | optimized for | steps to avoid usage (e.g., turn off VPN when |
| | real time traffic | making calls, use split tunneling, or dial in/dial |
| | | out). |
| 4 | [Reserved] | [Reserved] |
| 5 | Wireless | Avoid wireless connections for calls, or else |
| | networks can | several options are available to assist user: |
| | be unreliable | Avoid solid objects (walls, etc.) between user's |
| | | client and wireless access point. |
| | | Determine if a wireless network driver update is |
| | | available for the user's client. |
| | | If user uses audio from same IP address/subnet |
| | | with poor network conditions (often indicating |
| | | the user may be operating from a home or |
| | | business location where they can address |
| | | network infrastructure issues), recommend |
| | | investigation of wireless network type (and |
| | | recommend upgrade if needed). |
| | | Use a pre-call diagnostics tool to test connectivity |
| | | under the various conditions. |
| | | Consult local wireless network manager/ |
| | | administrator. |
| 6 | Reliance on | Due to the “best effort” nature of most public |
| | public\personal | networks (e.g., hotel, library, and other like |
| | networks can | networks) or personal networks, which are not |
| | produce | optimized for voice quality, voice quality can be |
| | inconsistent | unreliable even on a wired network. If the user |
| | audio | has control/influence over the network (e.g., |
| | experience | home network), and the issue impacting audio |
| | | quality is persistent, then they may improve |
| | | results by using a pre-call diagnostics tool to |
| | | capture poor results and provide them to the |
| | | service provider. |
| 7 | Unsupported | The device is not optimized and can provide poor |
| | Device | quality. Use supported device to improve call |
| | | quality. |

### Example 2

### User Interface

In this example, a user interface is described that can be used to display output that is automatically generated based on automatic analysis (e.g., by the automated analysis subsystem described above) of detected technical conditions of calls, as described herein. The user interface can be used to provide prescriptive guidance to users (e.g., IT personnel or end users) to help diagnose and/or resolve UC system issues (e.g., poor voice quality issues).

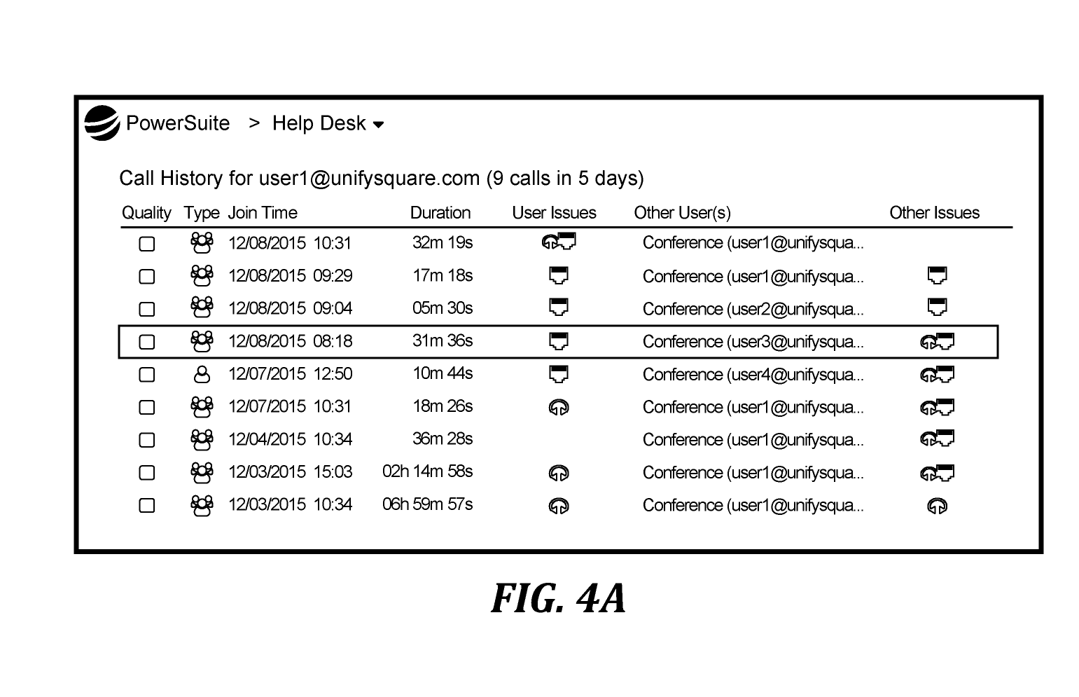

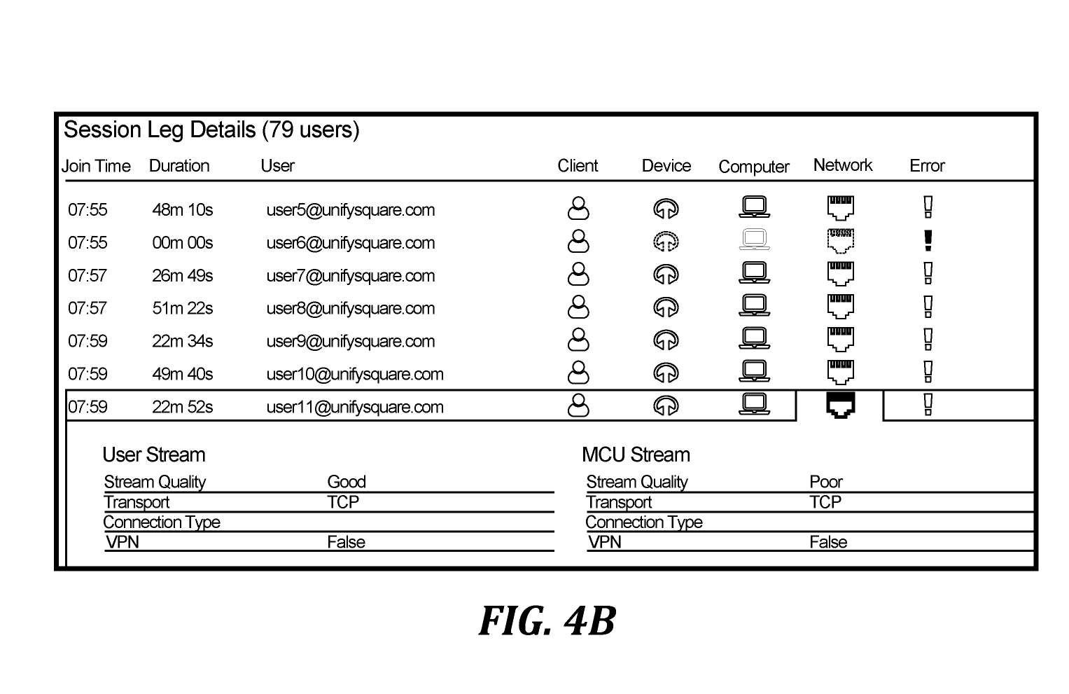

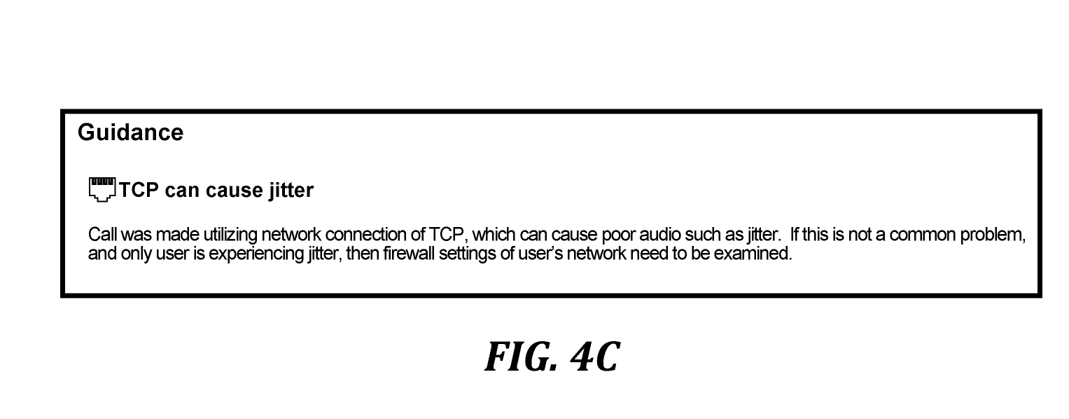

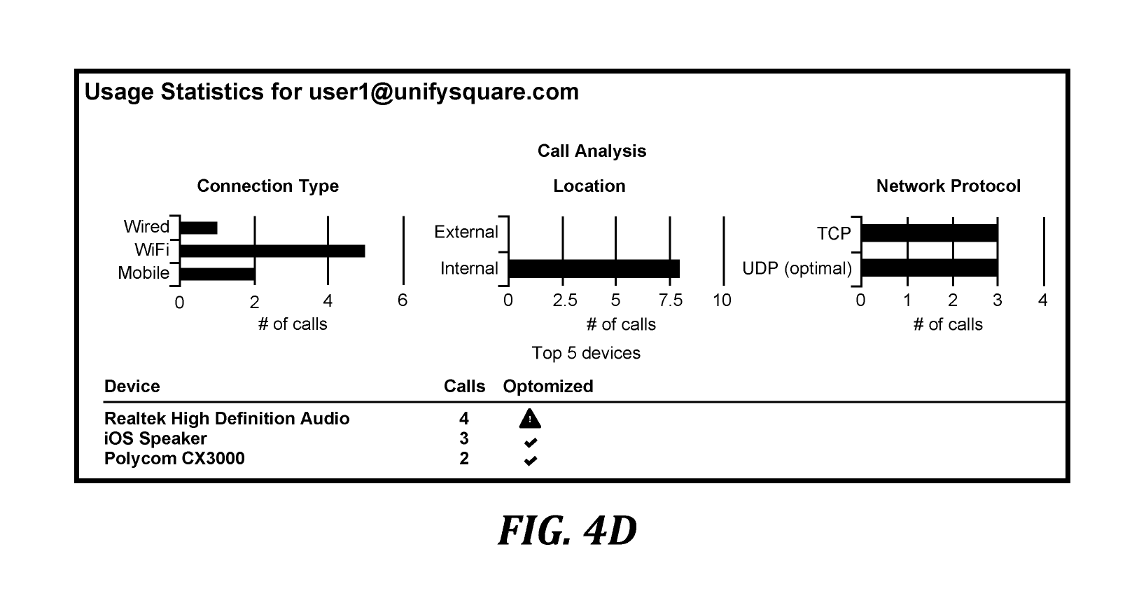

FIGS. 4A-4D are screen shots of a user interface for displaying information based on output generated by an automated call condition detection and analysis system. FIG. 4A is a screen shot of an illustrative call history tab or pane of a user interface of an illustrative help desk application. The call history lists calls for the specified user with respective join times, durations, and other users involved in the call, along with icons indicating call quality, call type, user issues, and other issues. A conference call is highlighted on the call history list. The other issues icons for the highlighted call include a network icon, which may be red or otherwise highlighted to indicate that another user on the call may be associated with high priority quality issue. Further details of the highlighted conference call are depicted in FIG. 4B, which is a screen shot of an illustrative Session Leg Details tab or pane of the user interface.

The Session Leg Details include a list of specific users that participated in the conference call, with respective join times and durations, and icons indicating client, device, computer, network, and error information. A user (user11) is highlighted on the call history list. The highlighted network icon indicates that another user on the call may be associated with a high priority network issue. A detailed tab associated with the highlighted network icon includes further information relating to the highlighted user, including Stream Quality, Transport, and VPN information. (Other information also may be associated with the call, but is not shown in FIG. 4B for ease of illustration.) The MCU (multi-conferencing control unit) Stream information indicates a poor quality stream from this unit. Because TCP is not a preferred protocol, it may also be highlighted, such as with a red color or other emphasis.

In this example, the automated analysis subsystem automatically generates the guidance shown in FIG. 4C based on detected technical conditions of the call, such as the stream quality of the call and the use of TCP for the call. The guidance in FIG. 4C indicates that TCP can cause poor audio. (See FIG. 3A and Guidance ID 1, described above.) The user interface elements depicted in FIGS. 4A, 4B, and 4C may be presented along with other information, such as the usage statistics tab shown in FIG. 4D, which can provide detailed call analysis information for the user regarding connection type, location, network protocol, devices, and the like.

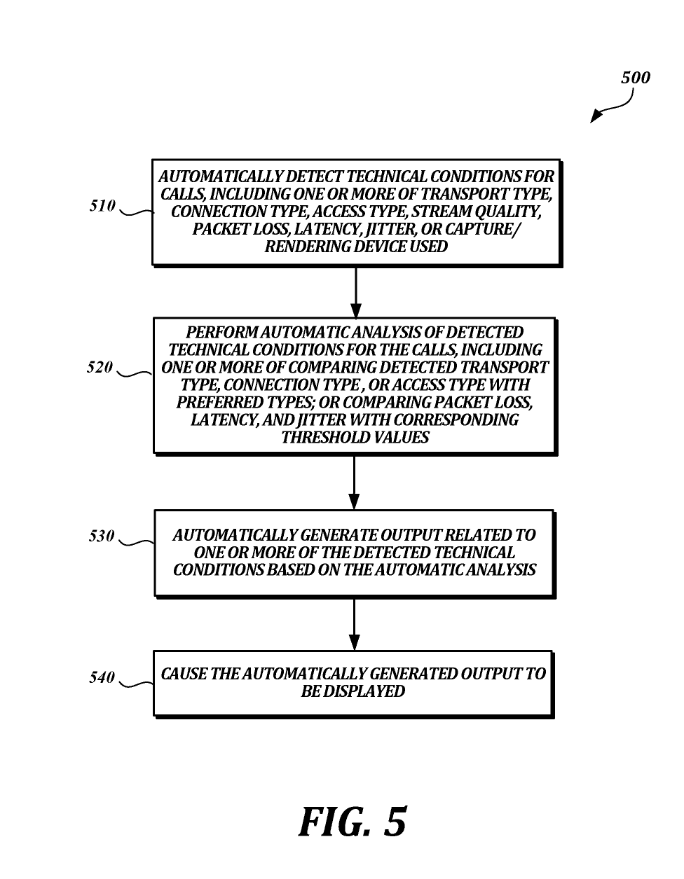

FIG. 5 is a flowchart of an illustrative process 500 for automatically detecting technical conditions for calls, analyzing the detected conditions, and generating output based on the analysis. The process 500 may be performed by a computing device that implements an automated call condition detection and analysis system as described herein. In the example shown in FIG. 5, at step 510 a computing device automatically detects technical conditions for calls. This may include receiving corresponding signals or information from client computing devices, servers, or other computing devices that participated in the calls. The technical conditions may include one or more of transport type (e.g., TCP, UDP), connection type (e.g., wired, wireless, mobile/cellular), access type (e.g., VPN or non-VPN), stream quality, packet loss, latency, jitter, and devices used during the calls (e.g., capture or rendering devices, such as headsets). At step 520, the computing device performs automatic analysis of the detected technical conditions. The automatic analysis may include comparing the detected transport type with a preferred transport type (e.g., non-TCP, such as UDP), comparing the detected connection type with a preferred connection type (e.g., wireless), comparing the detected access type with a preferred access type (e.g., non-VPN), or comparing packet loss, latency, or jitter with corresponding threshold values (e.g., maximum values or average values). At step 530, the computing device automatically generates output related to one or more of the detected technical conditions based at least in part on the automatic analysis. For example, the output may be triggered by a determination that a capture or rendering device used to make the call is not a supported device, that the transport type is TCP, by some other condition or combination of conditions. At step 540, the output is displayed, either at the computing device that performs the process, or at some other location. As will be understood in view of the examples described herein, many alternatives and variations to this process may be used in accordance with the disclosed subject matter.

### III. Operating Environment

Unless otherwise specified in the context of specific examples, described techniques and tools may be implemented by any suitable computing devices, including, but not limited to, laptop computers, desktop computers, smart phones, tablet computers, and/or the like.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client receives information provided by a server at a remote location.

FIG. 6 is a block diagram that illustrates aspects of an illustrative computing device 600 appropriate for use in accordance with embodiments of the present disclosure. The description below is applicable to servers, personal computers, mobile phones, smart phones, tablet computers, embedded computing devices, and other currently available or yet-to-be-developed devices that may be used in accordance with embodiments of the present disclosure.

In its most basic configuration, the computing device 600 includes at least one processor 602 and a system memory 604 connected by a communication bus 606. Depending on the exact configuration and type of device, the system memory 604 may be volatile or nonvolatile memory, such as read only memory (“ROM”), random access memory (“RAM”), EEPROM, flash memory, or other memory technology. Those of ordinary skill in the art and others will recognize that system memory 604 typically stores data and/or program modules that are immediately accessible to and/or currently being operated on by the processor 602. In this regard, the processor 602 may serve as a computational center of the computing device 600 by supporting the execution of instructions.

As further illustrated in FIG. 6, the computing device 600 may include a network interface 610 comprising one or more components for communicating with other devices over a network. Embodiments of the present disclosure may access basic services that utilize the network interface 610 to perform communications using common network protocols. The network interface 610 may also include a wireless network interface configured to communicate via one or more wireless communication protocols, such as WiFi, 2G, 3G, 4G, LTE, WiMAX, Bluetooth, and/or the like.

In the illustrative embodiment depicted in FIG. 6, the computing device 600 also includes a storage medium 608. However, services may be accessed using a computing device that does not include means for persisting data to a local storage medium. Therefore, the storage medium 608 depicted in FIG. 6 is optional. In any event, the storage medium 608 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like.

As used herein, the term “computer-readable medium” includes volatile and nonvolatile and removable and non-removable media implemented in any method or technology capable of storing information, such as computer-readable instructions, data structures, program modules, or other data. In this regard, the system memory 604 and storage medium 608 depicted in FIG. 6 are examples of computer-readable media.

For ease of illustration and because it is not important for an understanding of the claimed subject matter, FIG. 6 does not show some of the typical components of many computing devices. In this regard, the computing device 600 may include input devices, such as a keyboard, keypad, mouse, trackball, microphone, video camera, touchpad, touchscreen, electronic pen, stylus, and/or the like. Such input devices may be coupled to the computing device 600 by wired or wireless connections including RF, infrared, serial, parallel, Bluetooth, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 600 (e.g., a client device), or can be integral components of the computing device 600. In some embodiments, multiple input devices may be combined into a single, multifunction input device (e.g., a video camera with an integrated microphone). Any suitable input device either currently known or developed in the future may be used with systems described herein.

The computing device 600 may also include output devices such as a display, speakers, printer, etc. The output devices may include video output devices such as a display or touchscreen. The output devices also may include audio output devices such as external speakers or earphones. The output devices can be separate from and communicatively coupled to the computing device 600, or can be integral components of the computing device 600. In some embodiments, multiple output devices may be combined into a single device (e.g., a display with built-in speakers). Further, some devices (e.g., touchscreens) may include both input and output functionality integrated into the same input/output device. Any suitable output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

### IV. Extensions and Alternatives

Many alternatives to the described systems are possible. For example, although illustrative techniques are described herein with reference to voice quality for audio calls, such techniques can be adapted for other identifying and resolving issues relating to other features of UC services, such as audio conferences, video conferences, federated activity, PSTN usage in conferencing, and mobile usage.

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

Many alternatives to the user interfaces described herein are possible. In practice, the user interfaces described herein may be implemented as separate user interfaces or as different states of the same user interface, and the different states can be presented in response to different events, e.g., user input events. The elements shown in the user interfaces can be modified, supplemented, or replaced with other elements in various possible implementations.

While illustrative embodiments have been illustrated and described, it will be appreciated that various changes can be made therein without departing from the spirit and scope of the claimed subject matter.

The embodiments of the invention in which an exclusive property or privilege is claimed are defined as follows:

1. A computer system comprising at least one processor and computer-readable media having instructions stored thereon that, when executed by the at least one processor, cause the computer system to:
automatically detect technical conditions for a plurality of calls, wherein the detected technical conditions for the calls include transport type, connection type, a packet loss value, a latency value, and a jitter value;
perform automatic analysis of the detected technical conditions for the calls, wherein the automatic analysis includes comparing the detected transport type with a preferred transport type, comparing the detected connection type with a preferred connection type, and comparing the detected packet loss value, the detected latency value, and the detected jitter value with corresponding threshold values;
automatically generate output related to one or more of the detected technical conditions based on the automatic analysis; and
cause the automatically generated output to be displayed.

2. The computer system of claim 1, wherein the calls are voice calls.

3. The computer system of claim 1, wherein the detected technical conditions further include access type, and wherein the automatically generated output is triggered where the access type is virtual private network (VPN).

4. The computer system of claim 1, wherein the packet loss value, the latency value, and the jitter value are average values.

5. The computer system of claim 1, wherein the packet loss value, the latency value, and the jitter value are maximum values.

6. The computer system of claim 1, wherein the detected technical conditions further include stream quality, and wherein the automatic analysis further includes determining a classification of the stream quality.

7. The computer system of claim 1, wherein the automatically generated output is triggered where the detected transport type is Transmission Control Protocol (TCP).

8. The computer system of claim 1, wherein the automatically generated output is triggered where the detected connection type is wireless and at least one of the detected packet loss value, the detected latency value, and the detected jitter value exceeds its corresponding threshold value.

9. The computer system of claim 1, wherein the automatically generated output is displayed in a message or in a user interface of an application.

10. The computer system of claim 1, wherein the detected technical conditions further include capture device or rendering device, and wherein the automatically generated output is triggered where the capture device or rendering device is not a supported device.

11. A computer-implemented method comprising, by a computer system comprising at least one processor:
automatically detecting technical conditions for a plurality of calls, wherein the detected technical conditions for the calls include transport type, connection type, a packet loss value, a latency value, and a jitter value;
performing automatic analysis of the detected technical conditions for the calls, wherein the automatic analysis includes comparing the detected transport type with a preferred transport type, comparing the detected connection type with a preferred connection type, and comparing the detected packet loss value, the detected latency value, and the detected jitter value with corresponding threshold values;
automatically generating output related to one or more of the detected technical conditions based on the automatic analysis; and
causing the automatically generated output to be displayed.

12. The method of claim 11, wherein the calls are voice calls.

13. The method of claim 11, wherein the detected technical conditions further include access type, and wherein the automatically generated output is triggered where the access type is virtual private network (VPN).

14. The method of claim 11, wherein the detected technical conditions further include stream quality, and wherein the automatic analysis further includes determining a classification of the stream quality.

15. The method of claim 11, wherein the automatically generated output is triggered where the detected transport type is Transmission Control Protocol (TCP).

16. The method of claim 11, wherein the automatically generated output is triggered where the detected connection type is wireless and at least one of the detected packet loss value, the detected latency value, and the detected jitter value exceeds its corresponding threshold value.

17. The method of claim 11, wherein the automatically generated output is displayed in a message or in a user interface of an application.

18. The method of claim 11, wherein the detected technical conditions further include capture device or rendering device, and wherein the automatically generated output is triggered where the capture device or rendering device is not a supported device.

19. A non-transitory computer-readable medium having instructions stored thereon that, when executed by at least one processor, cause a computer system to:
automatically detect technical conditions for a plurality of calls, wherein the detected technical conditions for the calls include transport type, connection type, a packet loss value, a latency value, and a jitter value;
perform automatic analysis of the detected technical conditions for the calls, wherein the automatic analysis includes comparing the detected transport type with a preferred transport type, comparing the detected connection type with a preferred connection type, and comparing the detected packet loss value, the detected latency value, and the detected jitter value with corresponding threshold values;
automatically generate output related to one or more of the detected technical conditions based on the automatic analysis; and
cause the automatically generated output to be displayed.

20. The computer-readable medium of claim 19, wherein the calls are voice calls.
